(19) United States
(12) Patent Application Publication
(10) Pub. No.: US 2025/0068970 A1
(43) Pub. Date: Feb. 27, 2025

(54) AUTHENTICATION APPARATUS, COMMUNICATION SYSTEM, AUTHENTICATION METHOD, AND PROGRAM

(71) Applicant: NIPPON TELEGRAPH AND TELEPHONE CORPORATION, Tokyo (JP)

(72) Inventors: Nami ASHIZAWA, Tokyo (JP); Takafumi HARADA, Tokyo (JP); Ryohei SUZUKI, Tokyo (JP); Akira NAGAI, Tokyo (JP); Tomoaki WASHIO, Tokyo (JP)

(21) Appl. No.: 18/719,493

(22) PCT Filed: Jan. 12, 2022
(86) PCT No.: PCT/JP2022/000720

§ 371 Date: Jun. 13, 2024

(51) Int. Cl. G06N 20/00; G06F 21/44; H04L 9/00

(52) U.S. Cl. CPC G06N 20/00; G06F 21/44; H04L 9/008

(57) ABSTRACT

Disclosed is an authentication apparatus for authenticating validity of a machine learning model, which is held by an authentication target apparatus, includes a processor; and a memory storing instructions that cause the processor to execute a process including obtaining first classification basis information indicating information visualizing a classification basis of first input information of the machine learning model on a basis of information transmitted by the authentication target apparatus; acquiring, as information transmitted by a non-public information management apparatus, non-public information as a data set of valid second input information and second classification basis information indicating information visualizing a classification basis of the second input information; and authenticating the validity of the machine learning model of the authentication target apparatus by comparing the first classification basis information with the second classification basis information.

### TECHNICAL FIELD

The present disclosure relates to an authentication apparatus, a communication system, an authentication method, and a program.

### BACKGROUND ART

Artificial intelligence apparatuses having learned models are each constructed by learning using an appropriate architecture and learning data. At this time, it is normal to create a new machine learning model with reference to only public information of an existing machine learning model, but there is a person who intends to expose non-public information and create a new machine learning model with reference to this.

In contrast, an intellectual property protection technology has been proposed for verifying whether a newly created machine learning model has referred to non-public information of an existing machine learning model by recording input/output information reflecting non-public information related to a machine learning model in advance, passing the recorded input information to another machine learning model, and verifying whether the output information as recorded is returned (see Non Patent Literature 1).

### CITATION LIST

### Non Patent Literature

Non Patent Literature 1: Lukas, Nils, et al. “SoK: How Robust is Image Classification Deep Neural Network Watermarking?(Extended Version).” arXiv preprint arXiv:2108.04974 (2021).

### SUMMARY OF INVENTION

### Technical Problem

However, there is an increasing need to verify whether a newly created machine learning model has referred to non-public information of an existing machine learning model by a method other than the conventional method disclosed in Non Patent Literature 1.

The present invention has been made in view of the above point, and an object of the present invention is to verify whether a newly created machine learning model has referred to non-public information of an existing machine learning model by a method other than a conventional method.

### Solution to Problem

In order to achieve the above object, an invention according to claim 1 is an authentication apparatus that authenticates validity of a machine learning model held by an authentication target apparatus, the authentication apparatus including: a first acquisition unit that obtains first classification basis information indicating information visualizing a classification basis of first input information of the machine learning model on the basis of information transmitted by the authentication target apparatus; a second acquisition unit that acquires, as information transmitted by a non-public information management apparatus, non-public information as a data set of valid second input information and second classification basis information indicating information visualizing a classification basis of the second input information; and an authentication unit that authenticates the validity of the machine learning model of the authentication target apparatus by comparing the first classification basis information with the second classification basis information.

### Advantageous Effects of Invention

As described above, the present invention provides an effect that makes it possible to meet a need to verify whether a newly created machine learning model has referred to non-public information of an existing machine learning model by a method other than a conventional method.

### BRIEF DESCRIPTION OF DRAWINGS

FIG. 1 is a schematic diagram of a communication system according to an embodiment of the present invention.

FIG. 2 is a hardware configuration diagram of each apparatus of the communication system according to the embodiment.

FIG. 3 is a functional configuration diagram of each apparatus of a communication system according to a first embodiment.

FIG. 4 is a sequence diagram illustrating processing or operation of the communication system according to the first embodiment.

FIG. 5 is a functional configuration diagram of each apparatus of a communication system according to a second embodiment.

FIG. 6 is a sequence diagram illustrating processing or operation of the communication system according to the second embodiment.

### DESCRIPTION OF EMBODIMENTS

### [Outline of Overall Configuration]

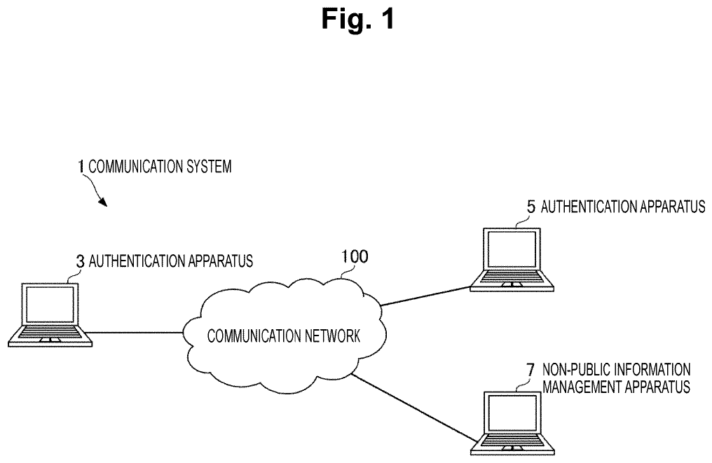

FIG. 1 is a schematic diagram of a communication system according to an embodiment of the present invention. As illustrated in FIG. 1, a communication system 1 of the present embodiment is constructed by an authentication target apparatus 3, an authentication apparatus 5, and a non-public information management apparatus 7.

In addition, the authentication target apparatus 3, the authentication apparatus 5, and the non-public information management apparatus 7 can communicate via a communication network 100 such as the Internet. The connection form of the communication network 100 may be either wireless or wired.

The authentication target apparatus 3 includes one or a plurality of computers. The authentication target apparatus 3 is an artificial intelligence apparatus that holds an architecture and learning data used to construct a learned machine learning model, and is a target for which the validity of the machine learning model is authenticated. For authentication performed by the authentication apparatus 5, the authentication target apparatus 3 transmits first input information of the machine learning model and information including a feature map having a single layer or a plurality of layers, which is necessary for classification of the first input information in a convolutional neural network (CNN), to the authentication apparatus 5.

Note that the machine learning model (machine learning algorithm) is not limited to the case of using a CNN. Other examples of the machine learning algorithm used by the machine learning model include a random forest (RF), a support vector machine (SVM), a neural network (NN), and the like.

Furthermore, the feature map is an example of classification feature information, which is necessary for generating a classification basis to be described later and is associated with the authentication target apparatus 3. Other examples of the classification feature information include a feature amount (an input element to the machine learning model), pseudo-learning data (a combination of output and input when some data is randomly selected from the learning data of the machine learning model and the selected data is input to the machine learning model), and the like.

The authentication apparatus 5 includes one or a plurality of computers. The authentication apparatus 5 is an apparatus that authenticates the validity of the machine learning model of the authentication target apparatus 3.

The non-public information management apparatus 7 includes one or a plurality of computers. For example, the non-public information management apparatus 7 is an apparatus that transmits, to the authentication apparatus 5, non-public information as a data set of valid second input information and second classification basis information indicating a second heat map visualizing a classification basis of the second input information for the authentication performed by the authentication apparatus 5. The heat map is an example of classification basis information, which is information visualizing classification information (or a name of a state in which classification information is visualized). Other examples of the classification basis information include a waveform in a case where the classification feature information is the above-described feature amount, a decision tree in a case where the classification feature information is the above-described pseudo-learning data, and the like.

### [Hardware Configuration]

### <Hardware Configuration of Each Apparatus>

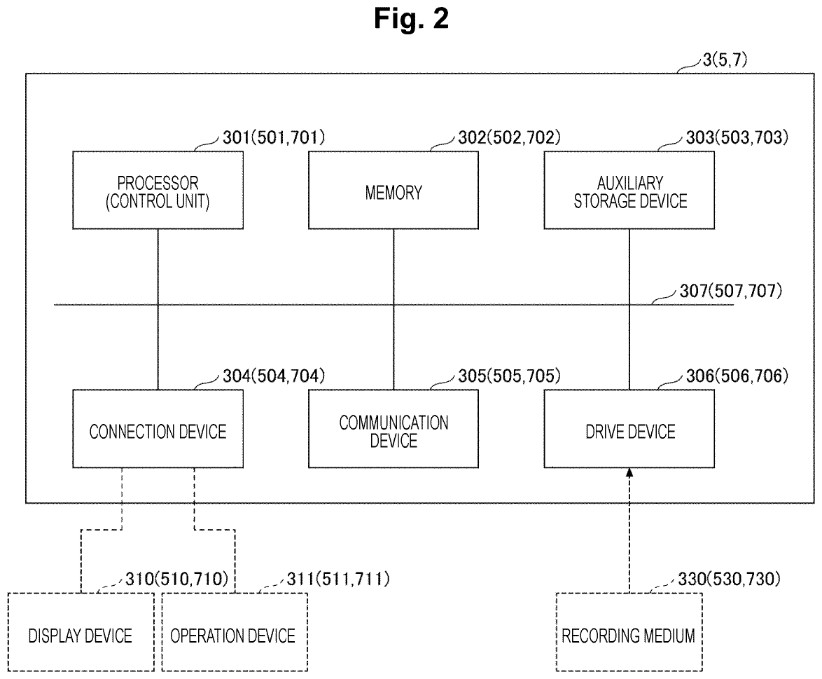

Next, a hardware configuration of each apparatus (the authentication target apparatus 3, the authentication apparatus 5, and the non-public information management apparatus 7) of the communication system 1 will be described with reference to FIG. 2. FIG. 2 is a hardware configuration diagram of each apparatus of the communication system according to the embodiment.

As illustrated in FIG. 2, the authentication target apparatus 3 includes a processor 301, a memory 302, an auxiliary storage device 303, a connection device 304, a communication device 305, and a drive device 306. Note that the pieces of hardware constituting the authentication target apparatus 3 are mutually connected via a bus 307.

The processor 301 serves as a control unit that controls the entire authentication target apparatus 3, and includes various arithmetic devices such as a central processing unit (CPU). The processor 301 reads various programs on the memory 302 and executes the programs. Note that the processor 301 may include general-purpose computing on graphics processing units (GPGPU).

The memory 302 includes a main storage device such as a read only memory (ROM) or a random access memory (RAM). The processor 301 and the memory 302 form a so-called computer, and the processor 301 executes various programs read on the memory 302, so that the computer implements various functions.

The auxiliary storage device 303 stores various programs and various types of information used when the various programs are executed by the processor 301.

The connection device 304 is a connection device that connects an external device (for example, a display device 310 or an operation device 311) and the authentication target apparatus 3.

The communication device 305 is a communication device for transmitting and receiving various types of information to and from other devices (which include an apparatus, a server, and a system).

The drive device 306 is a device for setting a recording medium 330. The recording medium 330 here includes a medium that optically, electrically, or magnetically records information, such as a compact disc read-only memory (CD-ROM), a flexible disk, or a magneto-optical disk. Furthermore, the recording medium 330 may include a semiconductor memory or the like that electrically records information, such as a read only memory (ROM) or a flash memory.

Note that the various programs installed in the auxiliary storage device 303 are installed, for example, by the distributed recording medium 330 being set in the drive device 306 and the drive device 306 reading the various programs recorded in the recording medium 330. Alternatively, the various programs installed in the auxiliary storage device 303 may be installed by being downloaded from a network via the communication device 305.

In addition, although FIG. 2 illustrates a hardware configuration of the authentication apparatus 5, the constituents are similar except that the reference numerals are changed from the 300 series to the 500 series, and thus the description thereof will be omitted. Similarly, although FIG. 2 illustrates a hardware configuration of the non-public information management apparatus 7, the constituents are similar except that the reference numerals are changed from the 300 series to the 700 series, and thus the description thereof will be omitted.

### First Embodiment

### Functional Configuration of First Embodiment

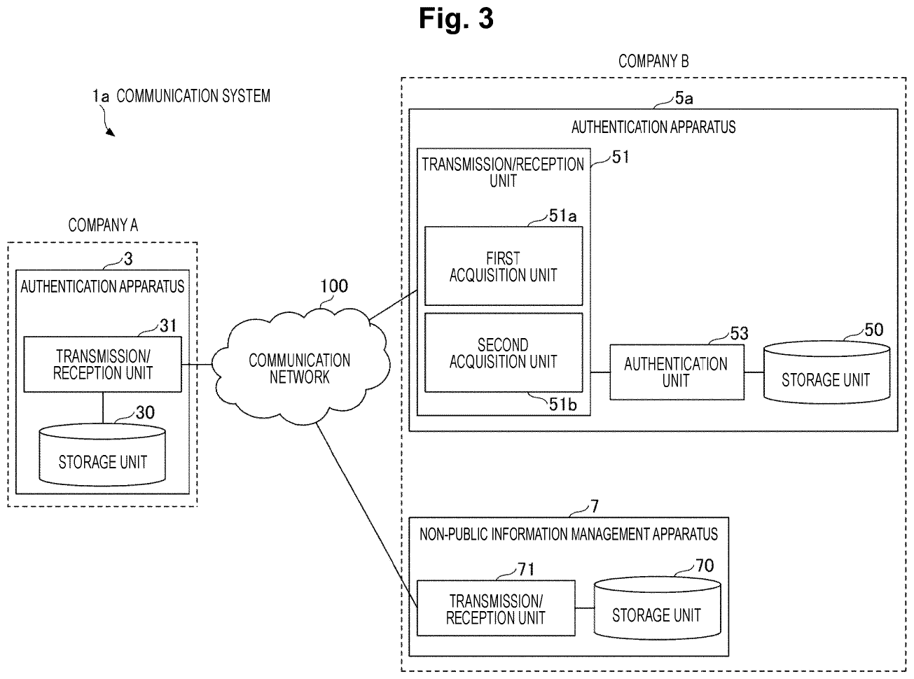

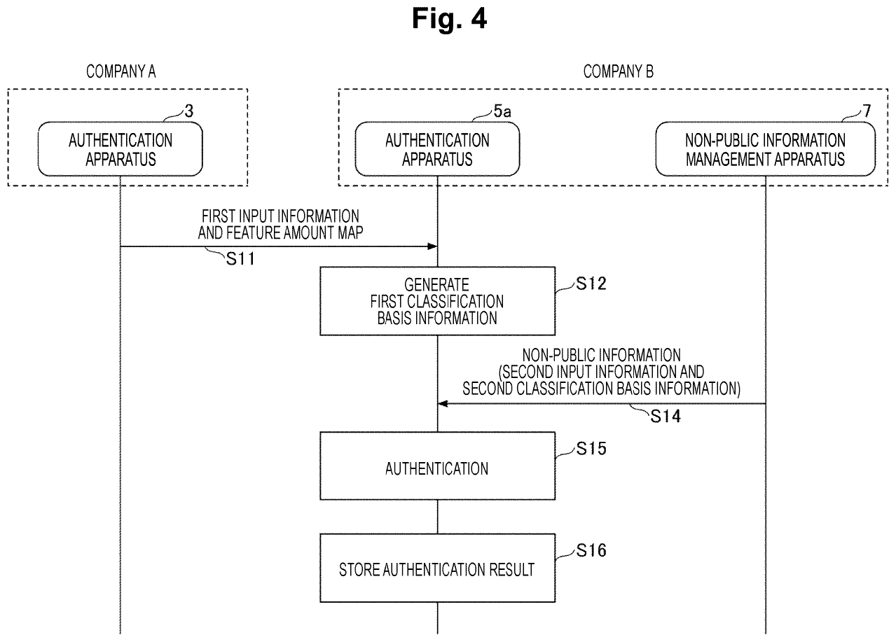

Next, a first embodiment of the present invention will be described with reference to FIGS. 3 and 4. FIG. 3 is a functional configuration diagram of each apparatus of a communication system according to the first embodiment. In the first embodiment, a company A manages an authentication target apparatus 3, and a company B manages an authentication apparatus 5a and a non-public information management apparatus 7. A communication system 1a includes the authentication target apparatus 3, the authentication apparatus 5a, and the non-public information management apparatus 7. Note that the authentication apparatus 5a is an example of the authentication apparatus 5 in FIG. 1. Furthermore, the communication system 1a is an example of the communication system 1.

<Functional Configuration of Authentication Target Apparatus 3>

The authentication target apparatus 3 includes a transmission/reception unit 31. The transmission/reception unit 31 is a function that a processor 301 causes the authentication target apparatus 3 to implement by using one or more programs installed in the authentication target apparatus 3. Furthermore, the authentication target apparatus 3 includes a storage unit 30. The storage unit 30 is implemented by a memory 302 or an auxiliary storage device 303. The storage unit 30 stores a machine learning model to be authenticated (verified).

The transmission/reception unit 31 transmits first input information of the machine learning model to be authenticated and information including a feature map having a single layer or a plurality of layers, which is necessary for classification of the first input information in a CNN, to the authentication apparatus 5a.

<Functional Configuration of Authentication Apparatus 5a>

The authentication apparatus 5a includes a transmission/reception unit 51 and an authentication unit 53. These units are functions that a processor 501 causes the authentication apparatus 5a to implement by using one or more programs installed in the authentication apparatus 5a. Furthermore, the authentication apparatus 5a includes a storage unit 50. The storage unit 50 is implemented by a memory 502 or an auxiliary storage device 503. The storage unit 50 stores data of an authentication result.

In addition, the transmission/reception unit 51 includes a first acquisition unit 51a and a second acquisition unit 51b. Among them, the first acquisition unit 51a receives the first input information and the information including the feature map having a single or a plurality of layers, which is necessary for classification of the first input information in the CNN, from the authentication target apparatus 3 by using Gradient-weighted Class Activation Mapping (Grad-CAM), and generates and obtains first classification basis information indicating a first heat map visualizing a classification basis of the first input information of the machine learning model to be authenticated on the basis of the first input information and the feature map.

Note that the first acquisition unit 51a may use another method instead of Grad-CAM. Examples of another method include Guided Grad-CAM for more detailed classification, Partial Dependence Plots (PDP) for generating a waveform as classification basis information, Born Again Trees for generating a decision tree as classification basis information, and the like. In a case where the first acquisition unit 51a uses PDP, the first acquisition unit 51a generates a waveform (an example of classification basis information) using a feature amount (an example of classification feature information) instead of the feature map (an example of classification feature information). Furthermore, in a case where the first acquisition unit 51a uses Born Again Trees, the first acquisition unit 51a generates a decision tree (an example of classification basis information) using pseudo-learning data (an example of classification feature information) instead of the feature map (an example of classification feature information).

The second acquisition unit 51b acquires, as information transmitted by the non-public information management apparatus 7, non-public information as a data set of valid second input information and second classification basis information indicating a second heat map visualizing a classification basis of the second input information.

Furthermore, the authentication unit 53 compares the first classification basis information with the second classification basis information to authenticate the validity of the machine learning model of the authentication target apparatus 3, which is to be authenticated. In this case, the authentication unit 53 determines that the machine learning model to be authenticated is valid in a case where the comparison result indicates a similarity equal to or greater than a threshold.

In addition, the authentication unit 53 compares the two pieces of information using a homomorphic encryption (HE) technology. In the homomorphic encryption technology, a plurality of pieces of encrypted data can be compared, and encrypted data and unencrypted data (plaintext) can also be compared. Note that, in the case of comparison between plaintexts, the authentication unit 53 may not use the homomorphic encryption technology.

### <Functional Configuration of Non-Public Information Management Apparatus 7>

The non-public information management apparatus 7 includes a transmission/reception unit 71. The transmission/reception unit 71 is a function that a processor 701 causes the non-public information management apparatus 7 to implement by using one or more programs installed in the non-public information management apparatus 7. Furthermore, the non-public information management apparatus 7 includes a storage unit 70. The storage unit 70 is implemented by a memory 702 or an auxiliary storage device 703. The storage unit 70 stores the non-public information as the data set of the valid second input information and the second classification basis information indicating the second heat map visualizing the classification basis of the second input information. Note that the non-public information may be encrypted or unencrypted. In the case of being encrypted, it is possible to prevent an act by a malicious attacker, such as exposing the non-public information and creating a new artificial intelligence apparatus without permission with reference to the non-public information.

The transmission/reception unit 71 transmits, to the authentication apparatus 5a, the non-public information as the data set of the valid second input information and the second classification basis information indicating the second heat map visualizing the classification basis of the second input information.

### Processing or Operation in First Embodiment

Next, processing or operation of the communication system 1a will be described with reference to FIG. 4.

The first acquisition unit 51a of the authentication apparatus 5a receives first input information of a machine learning model to be authenticated and information on a feature map having a single layer or a plurality of layers, which is necessary for classification of the first input information in a CNN, from the authentication target apparatus 3 (S11). Furthermore, the first acquisition unit 51a generates and obtains first classification basis information indicating a first heat map visualizing a classification basis of the first input information of the machine learning model to be authenticated on the basis of the first input information and the feature map (S12).

Next, the second acquisition unit 51b of the authentication apparatus 5a acquires, as information transmitted by the non-public information management apparatus 7, non-public information as a data set of valid second input information and second classification basis information indicating a second heat map visualizing a classification basis of the second input information (S14).

Next, the authentication unit 53 compares the first classification basis information with the second classification basis information to authenticate the validity of the machine learning model of the authentication target apparatus 3 (S15).

Finally, the storage unit 50 stores data of the authentication result by the authentication unit 53.

As described above, the processing or operation in the first embodiment ends.

### Effects of First Embodiment

As described above, according to the first embodiment, the authentication is performed by use of the first classification basis information indicating the heat map generated from the input information and the feature map, instead of a data set including a set of input information and output information of the machine learning model to be authenticated. Therefore, there is an effect that makes it possible to meet a need to verify whether a newly created machine learning model has referred to non-public information of an existing machine learning model by a method other than a conventional method.

In addition, in a case where an attacker creates a new machine learning model (authentication target apparatus) with reference to non-public information, an attack on a user may be set in the authentication target apparatus of the attacker. Therefore, when a machine learning model is used, it is necessary to confirm that the machine learning model that a user desires to use is not a machine learning model created by an attacker who has exposed non-public information related to another machine learning model. However, in the conventional method disclosed in Non Patent Literature 1, input/output information necessary for verifying whether the machine learning model is a machine learning model created by an attacker with reference to non-public information related to another machine learning model is not disclosed to the user of the machine learning model, and thus the authentication apparatus 5a cannot perform authentication (verification). On the other hand, the present embodiment uses the first classification basis information indicating the first heat map visualizing the classification basis of the first input information based on the first input information and the feature map information instead of the input/output information, so that the input information is disclosed to the user of the machine learning model, and the first classification basis information is concealed from the user. As a result, there is an effect that enables any person including the user of the machine learning model to verify whether the machine learning model is a machine learning model created by an attacker.

### Second Embodiment

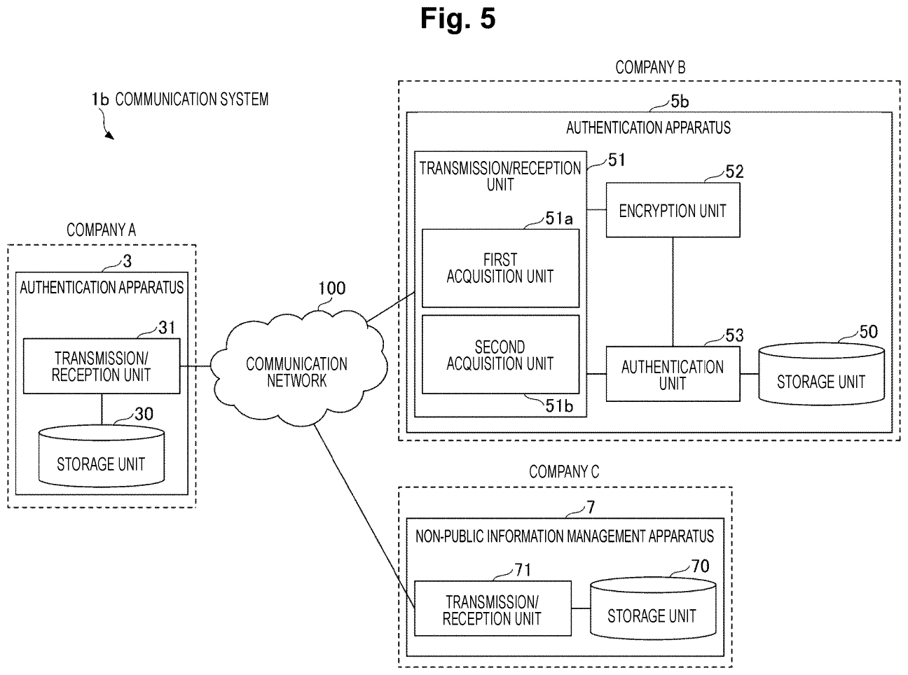

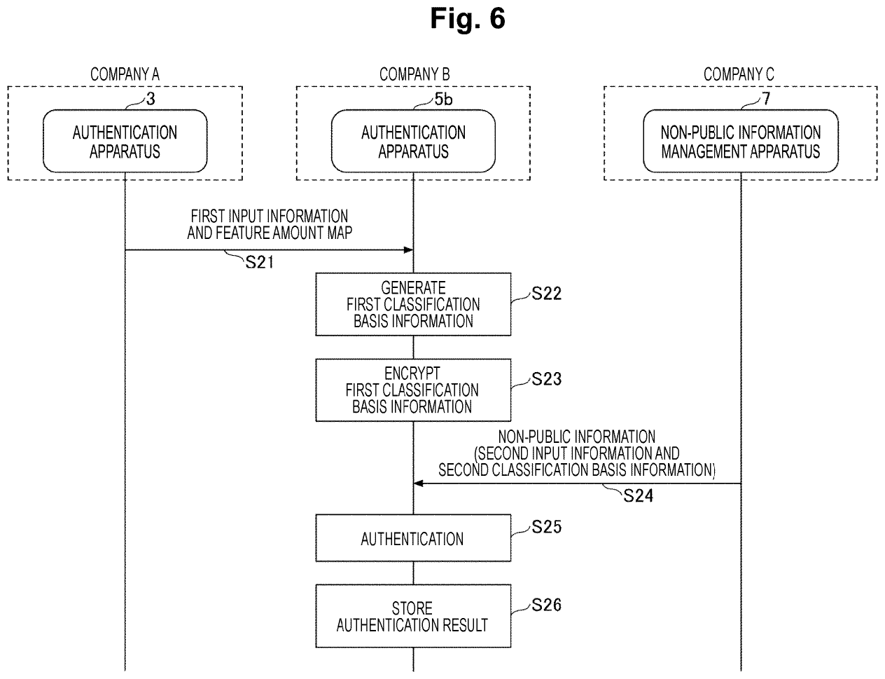

Next, a second embodiment of the present invention will be described with reference to FIGS. 5 and 6. Note that, since the second embodiment has a large number of parts in common with the first embodiment, different parts will be mainly described.

### Functional Configuration of Second Embodiment

FIG. 5 is a functional configuration diagram of each apparatus of a communication system according to the second embodiment. FIG. 6 is a sequence diagram illustrating processing or operation of the communication system according to the second embodiment.

In the second embodiment, a company A manages an authentication target apparatus 3, a company B manages an authentication apparatus 5b, and a company C manages a non-public information management apparatus 7. A communication system 1b includes the authentication target apparatus 3, the authentication apparatus 5b, and the non-public information management apparatus 7. Note that the authentication apparatus 5b is an example of the authentication apparatus 5 in FIG. 1. Furthermore, the communication system 1b is an example of the communication system 1.

Note that, since the authentication target apparatus 3 and the non-public information management apparatus 7 are similar to those of the first embodiment, the description thereof will be omitted.

<Functional Configuration of Authentication Apparatus 5b>

The authentication apparatus 5b has a similar configuration except that an encryption unit 52 is added to the authentication apparatus 5a. Each of the units including the encryption unit 52 is a function that a processor 501 causes the authentication apparatus 5b to implement by using one or more programs installed in the authentication apparatus 5b.

The encryption unit 52 encrypts first classification basis information acquired by a first acquisition unit.

### Processing or Operation in Second Embodiment

Next, processing or operation of the communication system 1b will be described with reference to FIG. 6.

In the second embodiment, steps of processing (S21, S22, S24, S25, and S26) are similar to the steps of processing (S11, S12, S14, S15, and S16) in the first embodiment, respectively, and thus the description thereof will be omitted.

In the second embodiment, after the processing (S22), the encryption unit 52 encrypts the first classification basis information acquired by generation by the first acquisition unit. In this case, the authentication unit 53 uses the homomorphic encryption technology.

### Effects of Second Embodiment

As described above, according to the present embodiment, in addition to the effects of the first embodiment, even if non-public information is encrypted, the first classification basis information is encrypted, whereby the authentication unit 53 can perform authentication using the homomorphic encryption technology.

### [Supplement]

The present invention is not limited to the above-described embodiments, and may be configured or processed (operated) as described below.

The authentication target apparatus 3, the authentication apparatus 5, and the non-public information management apparatus 7 can also be implemented by a computer and a program, and this program can be recorded in a (non-transitory) recording medium or provided through a network such as the Internet.

### REFERENCE SIGNS LIST

1 Communication system
1a Communication system
1b Communication system
3 Authentication target apparatus
5 Authentication apparatus
7 Non-public information management apparatus
51 Transmission/reception unit
51a First acquisition unit
51b Second acquisition unit
52 Encryption unit
53 Authentication unit
50 Storage unit
100 Communication network

1. An authentication apparatus for authenticating validity of a machine learning model, the machine learning model being held by an authentication target apparatus, the authentication apparatus comprising:
a processor; and
a memory storing instructions that cause the processor to execute a process, the process including
obtaining first classification basis information indicating information visualizing a classification basis of first input information of the machine learning model on a basis of information transmitted by the authentication target apparatus;
acquiring, as information transmitted by a non-public information management apparatus, non-public information as a data set of valid second input information and second classification basis information indicating information visualizing a classification basis of the second input information; and
authenticating the validity of the machine learning model of the authentication target apparatus by comparing the first classification basis information with the second classification basis information.

2. The authentication apparatus according to claim 1, wherein the obtaining includes receiving, as the information transmitted by the authentication target apparatus, the first input information and classification feature information, the classification feature information being necessary for classification of the first input information in a machine learning algorithm and being associated with the authentication target apparatus, and generating and obtaining the first classification basis information on a basis of the first input information and the classification feature information.

3. The authentication apparatus according to claim 1, wherein the process further comprises:
encrypting the first classification basis information acquired in the obtaining, wherein
the authenticating includes authenticating the validity of the machine learning model of the authentication target apparatus by comparing the encrypted first classification basis information with the second classification basis information.

4. The authentication apparatus according to claim 1, wherein the second classification basis information is already encrypted when the non-public information management apparatus transmits the second classification basis information.

5. The authentication apparatus according to claim 1, wherein the obtaining includes obtaining the first classification basis information indicating a heat map as the information visualizing the classification basis of the first input information by using Grad-CAM or Guided Grad-CAM.

6. The authentication apparatus according to claim 1, wherein the authenticating includes performing authentication by using a homomorphic encryption technology.

7. An authentication method executed by an authentication apparatus for authenticating validity of a machine learning model, the machine learning model being held by an authentication target apparatus, the authentication method comprising:
causing the authentication apparatus to execute a process including
obtaining first classification basis information indicating information visualizing a classification basis of first input information of the machine learning model on a basis of information transmitted by the authentication target apparatus;
acquiring, as information transmitted by a non-public information management apparatus, non-public information as a data set of valid second input information and second classification basis information indicating information visualizing a classification basis of the second input information; and
authenticating the validity of the machine learning model of the authentication target apparatus by comparing the first classification basis information with the second classification basis information.

8. A non-transitory computer-readable recording medium having computer-readable instructions stored thereon, which when executed, cause a computer to execute the authentication method according to claim 7.
